(19) United States
(12) Patent Application Publication
(10) Pub. No.: US 2020/0345569 A1
(43) Pub. Date: Nov. 5, 2020

(54) Two-point, four points and multiple points lifting patient lifting robots

(71) Applicant: MULTI TOWER COMPANY IVS, Odense SOE (DK)

(72) Inventors: Leonid Paramonov, Odense SOE (DK); Arnd Baurichter, Odense SOE (DK)

(21) Appl. No.: 16/642,809

(22) PCT Filed: Aug. 29, 2018
(86) PCT No.: PCT/DK2018/050214

§ 371 Date: Feb. 27, 2020

(30) Foreign Application Priority Data
Aug. 30, 2017 (DK) PA 2017 70654

(51) Int. Cl. A61G 7/10

(52) U.S. Cl. CPC A61G 7/1019; A61G 7/1015; A61G 7/1061; A61G 7/1051; A61G 7/1046

(57) ABSTRACT

There is provided a lifting robot suitable for lifting and transferring a person. Especially there is provided a patient lift apparatus with collapsible vertical and horizontal columns that allows the apparatus to change its height and width. Specifically there is provided a patient lifting robot having a frame for lifting and carrying persons. The frame has adjustable length and width, since the frame comprises two vertically collapsible columns for adjusting the height of the frame, and one horizontally collapsible beam for adjusting the width of the frame.

### FIELD OF INVENTION

The present invention relates to a lifting robot suitable for lifting and transferring a person. More particularly, the invention relates to a patient lifting apparatus with collapsible vertical and horizontal columns that allows the apparatus to change its height and width, and where 2-point, 4-point or multi-point lifting system is part of the robot for providing further flexibility and security.

### BACKGROUND OF THE INVENTION

It is known from FR483565 to provide a lifting device comprising two support members each having vertical legs and transverse arms, said arms being pivotable relative to one another about a vertical axis, and a hoist supported by one of the support members. When this lifting device is to pass through a doorway it may be necessary to displace the two support members angularly so that the whole device becomes sufficiently slim. This is not very easy under load.

EP0858311 discloses a patient lifting robot having a frame for lifting and carrying persons, said frame having adjustable length and width, wherein the frame comprises two vertically collapsible columns for adjusting the height of the frame, and one horizontally collapsible beam for adjusting the width of the frame. EP0962211 and U.S. Pat. No. 9,248,065 disclose similar features as above.

EP0858311 further describes that the vertically collapsible columns, and the horizontally collapsible beam is selected from telescopic/scissor joints. U.S. Pat. No. 9,248,065 discloses that in the patient lifting robot vertically collapsible columns are comprised of a sliding trolley with a hoist system connected to the horizontally collapsible beam.

There is a need to improve an interface for human-robot interaction that enable the user to more correctly adjust the lifting capability in a robot that uses height of hoist and columns and transverse movement to lift the person to be carried.

### SUMMARY OF THE INVENTION

The present invention provides a patient lifting robot having a frame for lifting and carrying persons, said frame having adjustable length and width, wherein the frame comprises two vertically collapsible columns for adjusting the height of the frame, and one horizontally collapsible beam for adjusting the width of the frame. Further, the present invention provides means that allows for the variable length horizontal beam of the robot to be down-rated in terms of structural load specifications to just take axial loads, which saves material costs and engineering efforts. Also, according to the present invention no lifting device needs to be attached to the horizontal beams, which makes it easier to use the same telescopic devices as used for the columns, which again saves costs and engineering and system integration efforts.

The inventors have surprisingly found that using multiple point lifting schemes extends the application range and adds new functionalities which have so far not been possible with today's available systems.

In one embodiment of the present invention there is provided a four-point or multipoint lifting feature, which enables orienting the patient in three axes. Thereby, patients with e.g. single-sided paralyses (apoplexy patients), patients with lesions/injuries in spine or extremities, or patients in need for re-orientation in bath tubs, may acquire further support relative to prior art lifting solutions.

In a further aspect of the present invention two or more robots may be coupled to each other and synchronised in their control systems, whereby multiple point lifting can be achieved. Multi-point lifting increases the load capacity of the lifts which extends their application to bariatric patients and to patients with particular lifting needs due to their physical disabilities

Specifically the present invention provides lifting robot having a frame for lifting and carrying persons, comprising two vertically collapsible columns (1) for adjusting the height of the frame, one horizontally collapsible beam (2) for adjusting the width of the frame, and a base frame (3) provided with wheels for movement of the lifting robot, wherein winches (7) are attached inside or on the vertically collapsible columns (1), each of said winches (7) provided with a belt (4) that extends from the winch (7) and is connected to a point (5) or a yoke that is attached to means for lifting patients (6), said lifting robot provided with a control unit connected with the winches (7) and programmed to ensure synchronous movement of the belts (4).

In a preferred embodiment of the present invention the vertically collapsible columns and the horizontally collapsible beam are selected from telescopic joints, scissor lifts, hydraulic lifts and electrical actuators.

In order to improve flexibility in the lifting robot supplementary winches may be attached to the vertically collapsible columns thereby establishing a four point or multipoint lifting configuration. The supplementary winches are in such an embodiment preferably attached at the bottom or on the side of the vertically collapsible columns and said supplementary winches are controlled in conjunction with the two winches at the top of the vertically collapsible columns, whereby the orientation of the lifted object is controlled in 3 axes.

The belts may be selected from cables, wires, and ropes, whereas the means for lifting patients may be selected from straps, harnesses and the like.

In a second aspect of the present invention there is provided a multiple lifting robot comprising two or more lifting robots of the above defined robots, wherein such robots are coupled and synchronized in their control systems so as to provide multiple point lifting.

### BRIEF DESCRIPTION OF THE DRAWINGS

FIG. 1 shows the robot with 2-point lifting device.

FIG. 2 is a view of robot with 2-point lifting device, changing of position relative to columns and beams.

FIG. 3 shows the robot with 2-point lifting device and bar extender.

FIG. 4 shows the robot with 4-point lifting device.

FIG. 5 shows the robot with 4 point lifting device with varying angles of lifting sling.

FIG. 6 shows two robots connected in multiple point lifting configuration with increased lifting capacity, and where belts are connected by bar to single point lifting hanger.

FIG. 7 shows two robots connected in multiple point lifting configuration with increased lifting capacity, and where belts are connected directly to single point lifting hanger.

FIG. 8 shows two robots connected in multiple point lifting configuration with increased lifting capacity, and where belts are connected sling with multiple lifting points.

FIG. 9 shows two robots connected in multiple point lifting configuration with increased lifting capacity, and where belts are connected sling with multiple lifting points with re-orientation capability.

FIG. 10 shows a motorized winch for varying the belt lengths.

FIG. 11 shows a motorized winch for varying the belt length integrated in the bottom structure of the robot.

FIG. 12 shows a motorized winch with force sensor.

FIG. 13 shows a multiple point lifting device obtained by concatenating multiple robots in a train-like configuration

FIG. 14 shows the robot with multiple lifting points.

FIG. 15 shows the robot in a tilted position which the orientation sensor is detecting.

### DETAILED DESCRIPTION OF THE INVENTION

Below the invention is described in more detail with reference to preferred aspects and embodiments thereof.

Prior art lifting solutions use single point lifting, which don't have the possibility to apply forces on several points of slings, straps or harnesses. In order to cope with this challenge the present invention therefore utilizes the conversion of the mechanical load on the horizontal beam during lifting by mounting winches with belts (or cables, wires, ropes) to the upper end of each vertical column. The ends of the belts are firmly connected to a point or a yoke that is attached to means for lifting patients (straps, harnesses, or alike). The winches are controlled individually, which enables automated control of the lifting location and direction.

By adding supplementary winches to the vertical columns in a four point lifting configuration, for example at the bottom of each column and by controlling them the same way as the two winches at the top of the columns, the orientation of the lifted object can be controlled in 3 axes in addition to the 2D location. The extra winches can also be used for aiding the operator of the device in placing the sling, harness or lifting straps under the patient in a bed or chair. By adding further supplementary winches to the vertical columns achieving a multipoint lifting configuration, a precise controlled motion can be obtained.

The present invention as shown in the Figures, includes a patient lifting robot with two telescopic collapsible columns (1) and one telescopic collapsible beam (2), a base assembly (3) provided with wheels for moving the robot, a battery housing, an interface allowing human-robot interaction, and force control sensing.

The telescopic columns (1) are generally formed from several tubes of different sections, adapted to slide in each other through the presence of linear guide means disposed over the length of these tubes between each of them. The present invention is comprised of two vertical telescopic collapsible columns, and one horizontal telescopic collapsible beam (2) which collapse and expand to a plurality of heights and widths.

The lifting robot is controlled by force sensing control. The user can move the robot forwardly with a forward force and backwardly with a rearward force. This action may be detected by one or more of load sensors, potentiometers, strain gauges, capacitive sensors, piezoresistive or piezoelectric sensors, or any other types of sensors that are capable of detecting forces exerted by a user, and used to control the powered movement of patient lifting robot.

As was noted above, force sensors may include load cells, potentiometers, strain gauges, capacitive, piezoresistive or piezoelectric sensors, or any other types of sensing structures that are capable of detecting forces exerted by a user thereon. Typically such force sensors are arranged or configured so as to detect any and all force components that are exerted in generally any horizontal orientation, or that have any horizontal components to them.

In one exemplary embodiment the patient lifting robot further includes an intuitive interface for human-robot interaction that may be a touch display module, providing an easy-to-use interface without significant preparation time.

Hoisting systems for internally moving persons is an important part of the equipment in e.g. a hospital or a nursing home. These enable moving entirely or partially immobile persons or inhabitants between their bed, toilet, bath or other place of stay, without the care assistants having to do heavy lifting. Hoisting systems of this type often consist of an overhead rail system with a trolley that enables horizontal displacement, and a hoisting system suspended from the trolley that enables vertical displacement. The disclosed invention contains a sliding trolley allowing horizontal movement and a hoisting function carried out by the vertical telescopic collapsible columns allowing vertical movement with an interchangeable hook.

The patient lifting robot is wireless and thus must operate on battery power. The system may also include a battery charging module mating with the mobile robot battery plug module, and an alignment system that aligns the battery plug module with the battery charging module.

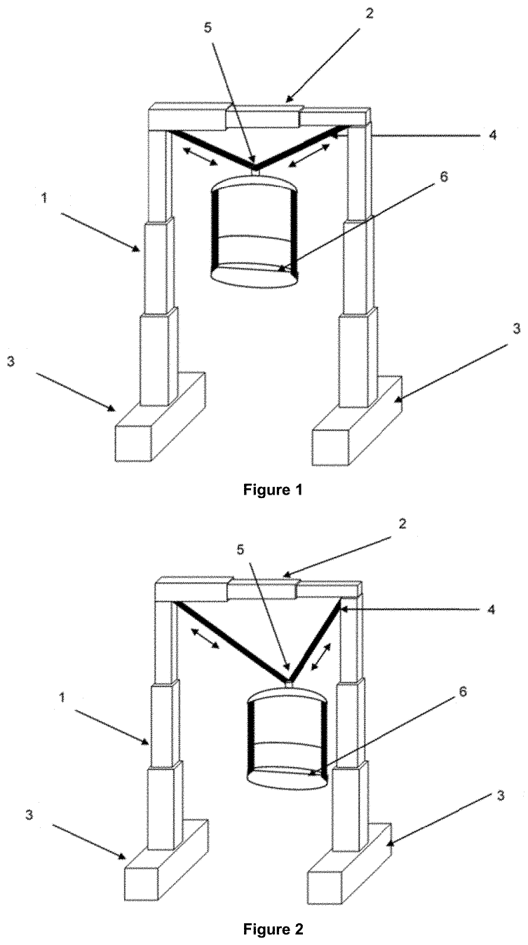

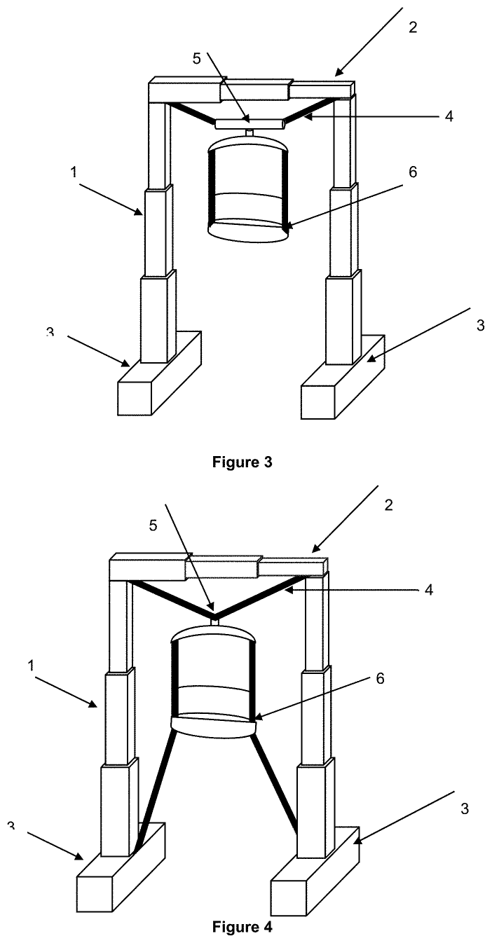

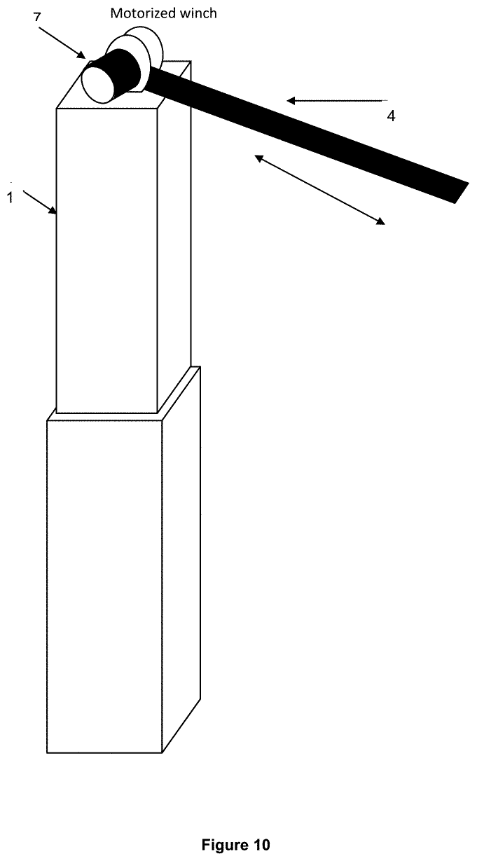

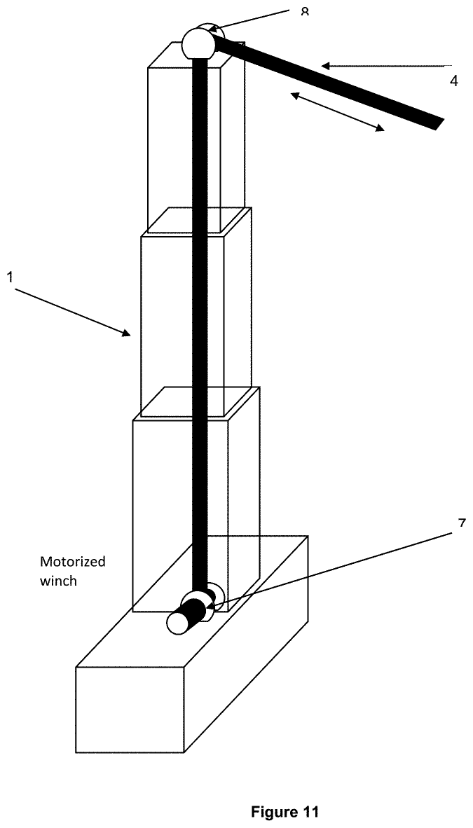

Referring to FIG. 1 there is shown how the lifting hanger is connected to two belts attached on the top of either column or at the end of the horizontal beam of the robot. The length of the belts is adjustable by automatically controlled winches, which are driven by electrical motors or hydraulic or pneumatic motors (see also FIGS. 10 and 11). As shown in FIG. 2 the length of the belts on each column can be varied individually by means of a control system thereby enabling correct positioning of the patient both vertically and horizontally. In the alternative embodiment shown in FIG. 3 the belts may be attached to a bar that again is connected to the hanger in order to extend the vertical lifting range at heavy load. In case that the hanger is rotatable further adjustment possibilities arise.

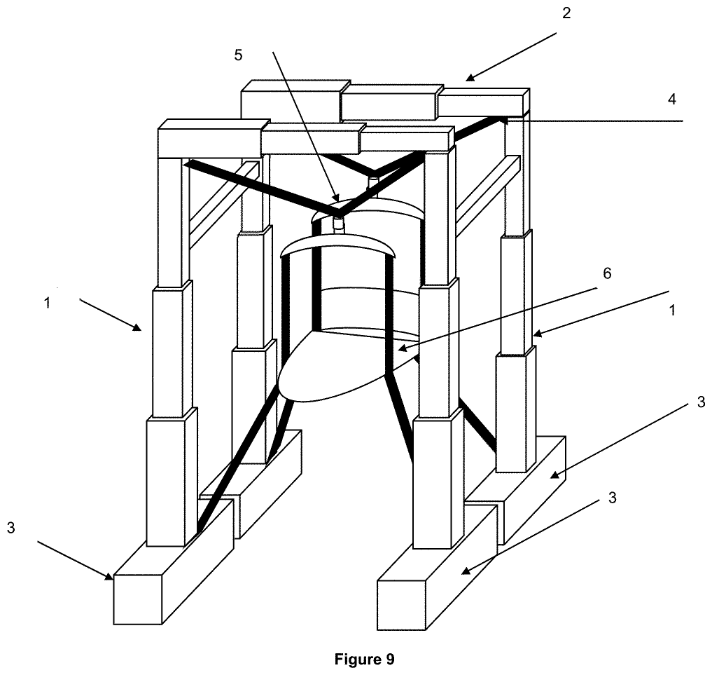

Applying to all of the FIGS. 1-13 the lifting robot has two vertically collapsible columns (1) for adjusting the height of the frame, one horizontally collapsible beam (2) for adjusting the width of the frame, and a base frame (3) provided with wheels for movement of the lifting robot, wherein winches (7) are attached inside or on the vertically collapsible columns (1), each of said winches (7) provided with a belt (4) that extends from the winch (7) and is connected to a point (5) or a yoke that is attached to means for lifting patients (6), said lifting robot provided with a control unit connected with the winches (7) and programmed to ensure synchronous movement of the belts (4).

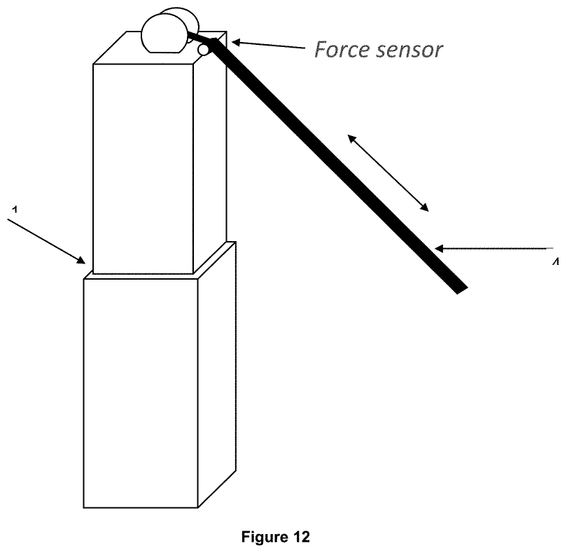

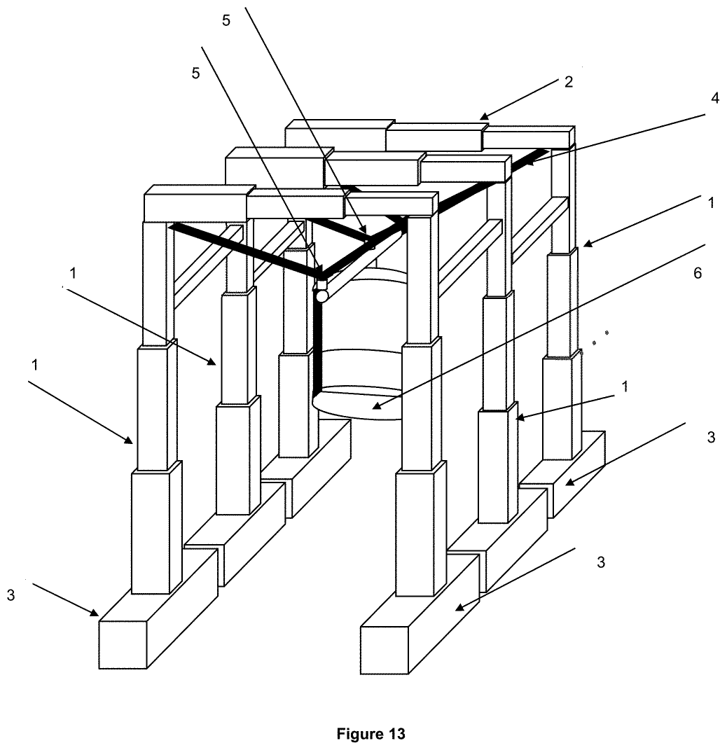

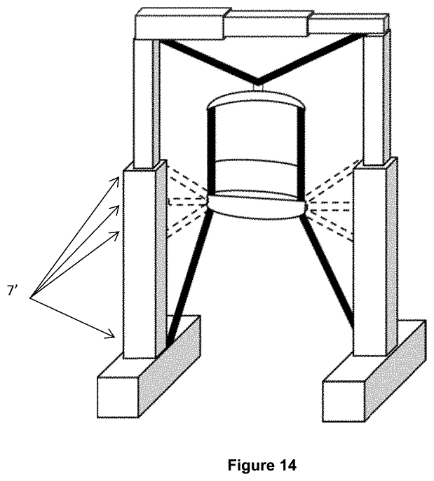

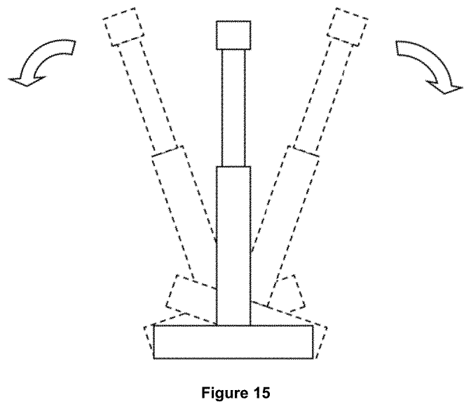

Preferably the belts are equipped with a load or force sensor in order to detect the load on the lifting belts (see FIG. 12). This features also allows for a safety stop, e.g. by virtue of an interlock system halting the operation in case of detection of overload.

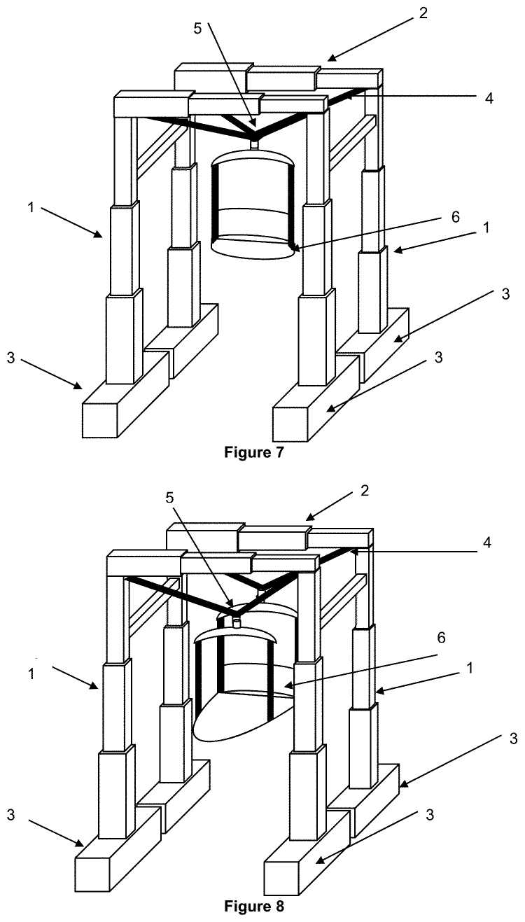

In a particularly interesting embodiment two or more lifts are coupled and through the control system in order to increase the lifting capacity and/or the number of lifting points pulling up; this is visualized in FIGS. 7-9, and 13.

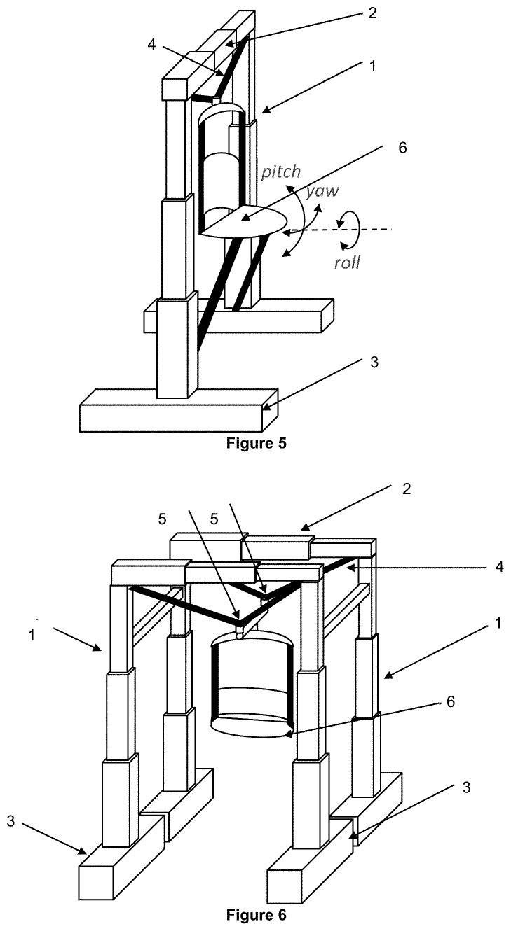

As appears from FIGS. 4 and 5 two or more belts can be attached to the columns in the bottom and/or between the bottom and the top in order to assist in the re-orientation of the patient lifted by slings and/or straps, which may also serve to assist the robot operator (nurse) in preparing the sling for lifting patients with a high degree of physical disability.

1. A lifting robot having a frame for lifting and carrying persons, comprising two vertically collapsible columns for adjusting the height of the frame, one horizontally collapsible beam for adjusting the width of the frame, and a base frame provided with wheels for movement of the lifting robot, wherein winches are attached inside or on the vertically collapsible columns or the horizontally collapsible beam, each of said winches provided with a belt that extends from the winch and is connected to a point or a yoke that is attached to means for lifting patients, said lifting robot provided with a control unit connected with the winches and programmed to ensure synchronous movement of the belts.

2. The lifting robot of claim 1, wherein said vertically collapsible columns, and said horizontally collapsible beam are selected from telescopic joints, scissor lifts, hydraulic lifts and electrical actuators.

3. The lifting robot of claim wherein each of said belts passing a pulley attached to the upper end of each vertically collapsible column.

4. The lifting robot of claim 3, wherein the pulley is associated with a load sensor.

5. The lifting robot o claim 1, wherein an orientation sensor is applied as part of an anti-tilting system for the lifting robot.

6. The lifting robot of claim 1, wherein the winches are located in the lower parts of two vertically collapsible columns.

7. The lifting robot of claim 1, wherein supplementary winches are attached to the vertically collapsible columns thereby establishing a four point lifting configuration.

8. The lifting robot of claim 1, wherein supplementary winches are attached to the vertically collapsible column or collapsible beam (thereby establishing a multipoint lifting and positioning configuration.

9. The lifting robot of claim 1, wherein the supplementary winches are attached at the bottom of the vertically collapsible columns and said supplementary winches are controlled via the control unit in conjunction with the winches at the top of the vertically collapsible columns.

10. The lifting robot of claim 1, wherein the supplementary winchesare configured to be twisted away from the vertical plane so as to provide to twist the means for lifting patients, whereby the orientation of the lifted object is controlled in 3 axes.

11. The lifting robot of claim 1, wherein the belts are selected from cables, wires, and ropes.

12. The lifting robot of claim 1, wherein the belts length position are measured by a sensor.

13. The lifting robot of claim 1, wherein an extender bar is used for reducing the horizontal force on the upper winches when the means for lifting patients in a vertical direction from a 2 point or multipoint winches position.

14. The lifting robot of claim 1, wherein the means for lifting patients are selected from straps, harnesses, or alike.

15. A multiple lifting robot comprising two or more lifting robots of claim 1, wherein the robots are coupled and synchronized in their control units so as to provide multiple point lifting.
